(19) United States
(12) Patent Application Publication
(10) Pub. No.: US 2026/0107921 A1
(43) Pub. Date: Apr. 23, 2026

(54) STYPTIC APPARATUS FOR PET'S CLAW OR BEAK AND METHOD FOR MANUFACTURING THE SAME

(71) Applicant: Minha Oh, Irvine, CA (US)

(72) Inventor: Minha Oh, Irvine, CA (US)

(21) Appl. No.: 18/920,670

(22) Filed: Oct. 18, 2024

(51) Int. Cl. A01K 13/00

(52) U.S. Cl. CPC A01K 13/003

(57) ABSTRACT

According to one of embodiments of the present disclosure, a styptic apparatus for a pet's claw or beak comprises: a styptic composition configured to stop bleeding from the claw or beak; and an application container including a container body including a shape that tapers in a front direction. The container body defines an inner space to store the styptic composition, the inner space is configured to accommodate the claw or beak, and the container body is configured to cover at least a portion of the claw or beak that is accommodated in the inner space.

### TECHNICAL FIELD

The present disclosure relates to a method for manufacturing a styptic composition provided with an applicator container for use in stopping bleeding from pets' claw or beak.

In addition, the present disclosure relates to a styptic composition for pets, particularly for stopping bleeding from the claws of pets or the beaks and claws of birds quickly and effectively, as well as a styptic apparatus including the styptic composition, a method for manufacturing the styptic composition, and a method of applying the styptic composition.

### BACKGROUND

Recently, as social interest in pets has increased, the number of people who consider pets as family members or companions has also risen. The pet market has been steadily growing, reaching $48 billion in 2010, $60.5 billion in 2015, $103 billion in 2020, and is projected to grow to $136 billion by 2023.

Particularly, with the expansion of the culture of living with pets at home, it has become common for people to trim the claws of dogs and cats or the beaks of birds themselves.

However, whether trimming a dog's or cat's claws or a bird's beak at home or taking them to a pet grooming salon or veterinary clinic, there is a risk that the pet's blood vessels may be damaged during the process due to the operator's mistake. This can cause sudden bleeding, which may interrupt the trimming process or lead to infection of the wound area. Therefore, it is essential to provide swift treatment to enhance the quality of life of pets and to quickly suppress the excessive blood flow from the damaged blood vessels.

In response to the growing pet market, there have been developments in styptic agents for animal claws and beaks. For instance, NCBIT Co., Ltd. has developed a powdered styptic agent for pets under the product name “NC-rH-V01.” Miracle Corp has developed a powdered styptic product called “Kwik Stop,” and Theracion Biomedical has created a liquid styptic composition that provides both hemostatic and pain-relief effects.

However, most of the conventional styptic agents for pets are in powder or liquid form, which poses several challenges. When applied to the bleeding area, the pet must be immobilized, which requires the pet to be restrained during use, causing inconvenience. If the pet is not restrained, the styptic composition can be easily washed or removed due to movement. Additionally, the styptic agent may easily fall off or cause contamination due to the animal's movement. When using fine powdered styptic agents, there is a risk of contaminating the surroundings and wasting the product, as the mixture of blood and powder creates a messy environment, reducing the efficacy of the styptic agent.

Therefore, there is a need for a new form of styptic agent for pets that is convenient, safe, and considers the surrounding environment while effectively stopping bleeding in pets.

### SUMMARY

This disclosure aims to address the above issues by providing anew type of styptic apparatus for pets that is convenient to use.

The objective of the present disclosure is to provide a new form of styptic composition for animal claws, which can effectively and quickly stop bleeding from animal claws or beaks. Unlike conventional powder or liquid forms, this styptic composition can be easily applied to the bleeding area in a one-step process. Once applied, it does not cause discomfort to the animal's movement and can remain attached for an extended period. Being water-soluble and harmless to the human body, it can be easily cleaned off with a wet tissue after use. The styptic composition is designed to adhere to the claw or beak in a simple, single-step application. That is, the styptic composition for pets that can easily stop bleeding from the claws or beaks of pets, remain attached to the bleeding area for an extended period without affecting the pet's movement, and maintain effective hemostasis.

Another objective of the present disclosure is to provide a method for manufacturing the styptic apparatus or the styptic composition for animal's claws or beak, and to offer this apparatus or composition in an applicator container that forms an integrated styptic for pet's claws or beaks.

A further objective of the present disclosure is to provide a method for stopping bleeding from animal's claws or beaks using the styptic composition of the present disclosure.

Furthermore, the disclosure aims to enhance convenience and cleanliness by providing the styptic composition in a specially designed application container.

To achieve the objectives of the present disclosure as described above, the present disclosure provides a styptic apparatus for a pet's claw or beak. A representative embodiment of the styptic apparatus for a pet's claw or beak includes: a styptic composition configured to stop bleeding from the claw or beak; and an application container including a container body including a shape that tapers in a front direction, wherein the container body defines an inner space to store the styptic composition, the inner space is configured to accommodate the claw or beak, and the container body is configured to cover at least a portion of the claw or beak that is accommodated in the inner space.

In one embodiment, the application container may be configured such that the claw or beak enters the inner space from a rear direction.

In one embodiment, the container body may forma hole at a front end configured to allow air to pass from the inner space.

In one embodiment, the container body may have an opening at a rear portion configured to allow the claw or beak to enter the inner space.

In one embodiment, the application container may further include a cap that is detachably connected to the container body to close the opening.

In one embodiment, the container body may forma hole at a front end configured to allow air to pass from the inner space.

In one embodiment, the styptic composition may include: sodium carboxy methyl cellulose or hydroxy ethyl cellulose; poly(ethylene glycol-ran-propylene glycol); glycerol; poloxamer 188; poloxamer 407; benzocaine or lidocaine; calcium phosphate; and kaolin or chitosan.

In one embodiment, the styptic composition may comprise: 1-4 weight percent of sodium carboxy methyl cellulose or hydroxy ethyl cellulose; 25-55 weight percent of poly(ethylene glycol-ran-propylene glycol); 10-35 weight percent of glycerol; 10-40 weight percent of poloxamer 188; 1-15 weight percent poloxamer 407; 0.1-3 weight percent of benzocaine or lidocaine; 1-4 weight percent of calcium phosphate; and 0.1-2 weight percent of kaolin or chitosan.

In one embodiment, the container body may be made of polyethylene (PE), polypropylene (PP), Polyvinyl chloride (PVC), or silicone.

In addition, the present disclosure provides a method for manufacturing the styptic apparatus. A representative embodiment of the method for manufacturing the styptic apparatus comprises manufacturing the styptic composition. The manufacturing the styptic composition includes: (a) mixing and heating sodium carboxy methyl cellulose or hydroxy ethyl cellulose, poly(ethylene glycol-ran-propylene glycol), glycerol, poloxamer 188, poloxamer 407, benzocaine or lidocaine, calcium phosphate, and kaolin or chitosan to prepare a mixture; (b) performing a deaeration process to remove air bubbles contained in the mixture; (c) pouring the deaerated mixture into a mold and refrigerating the mixture to solidify; and (d) reheating the solidified mixture to a designated temperature while kneading it into a paste form.

In one embodiment, in the mixing and heating, the mixture may be prepared by mixing: 1-4 weight percent of sodium carboxy methyl cellulose or hydroxy ethyl cellulose; 25-55 weight percent of poly(ethylene glycol-ran-propylene glycol); 10-35 weight percent of glycerol; 10-40 weight percent of poloxamer 188; 1-15 weight percent poloxamer 407; 0.1-3 weight percent of benzocaine or lidocaine; 1-4 weight percent of calcium phosphate; and 0.1-2 weight percent of kaolin or chitosan.

In one embodiment, a heating temperature of the mixture in the mixing and heating may be 60-90° C., and the heating time in the mixing and heating may be 16-24 hours.

In one embodiment, the deaeration process may be performed by using a vacuum oven.

In one embodiment, the solidified mixture may be reheated at 25° C.-45° C. to form a paste in the reheating, and the method may further comprise: (f) dispensing the mixture into the container body after the reheating.

In one embodiment, the animal may be a dog, cat, or bird.

When used on a bleeding animal's claw or beak, the user can simply remove the cap and apply the container body to the bleeding area of a pet's claw or beak in one step such that the container body covers the pet's claw or beak. This method offers a very simple and efficient way to stop bleeding from animal's claws or beaks. In addition, the method for applying the styptic composition can allow the styptic composition to create a protective barrier over the wound, thereby promoting rapid hemostasis and preventing further bleeding.

By using the method for applying the styptic composition, the styptic composition, after achieving hemostasis, can dissolve upon contact with water or moisture, allowing for easy removal without residue using a wet tissue or water-based cleaning solution, thereby ensuring hygienic removal after treatment.

In one embodiment of the present disclosure, the animal may be a dog, cat, or bird.

The styptic composition easily adheres to the bleeding area and can be cleanly removed with a wet tissue, ensuring hygienic use. The styptic composition is provided in a specially designed Cone-shaped application container made of PP, PE, PVC, or silicone material, which can be applied to the bleeding area in a single step by removing the cap. This ensures that the styptic composition does not easily fall off even with the pets movement and maintains the hemostatic effect.

### BRIEF DESCRIPTION OF THE DRAWINGS

FIG. 1 is a front view of an application container according to an embodiment of the present disclosure.

FIG. 2 is a top view of the application container of FIG. 1.

FIG. 3 is a side view of the application container of FIG. 1.

FIG. 4 is a back view of the application container of FIG. 1.

FIG. 5 is a photograph showing the shape of a side view of an application container according to an embodiment of the present disclosure.

FIG. 6 is a photograph showing the shape of a front view of the application container of FIG. 5.

### DETAILED DESCRIPTION

The present disclosure is characterized by providing a styptic composition. In addition, the present disclosure is characterized by providing a styptic apparatus including the styptic composition. Additionally, the present disclosure is characterized by providing both a method for manufacturing a styptic for animal's claws or beaks, in which a styptic composition containing various active ingredients is packaged in an applicator container (an application container), and a method for its use.

The present disclosure relates to a styptic designed to quickly and effectively stop bleeding from pets' claws or beaks. Unlike conventional powder or liquid styptics, this styptic composition is highly convenient, hygienic, and has a unique adhesive property that prevents it from easily falling off even if the pet moves. The styptic is composed of safe ingredients, including poloxamer, glycerin, carboxymethyl cellulose or hydroxyethyl cellulose, poly (ethylene glycol-ran-propylene glycol), benzocaine or lidocaine, calcium phosphate, kaolin or chitosan. It is packaged in a cone-shaped container, allowing the user to apply the styptic directly to the bleeding area in one step. The inclusion of antibacterial agents helps reduce the risk of infection, and it can be easily wiped off with a wet tissue, ensuring hygienic use. The disclosure forms an integrated final styptic composition through the interaction between the container and the styptic, and its individual components cannot be used independently.

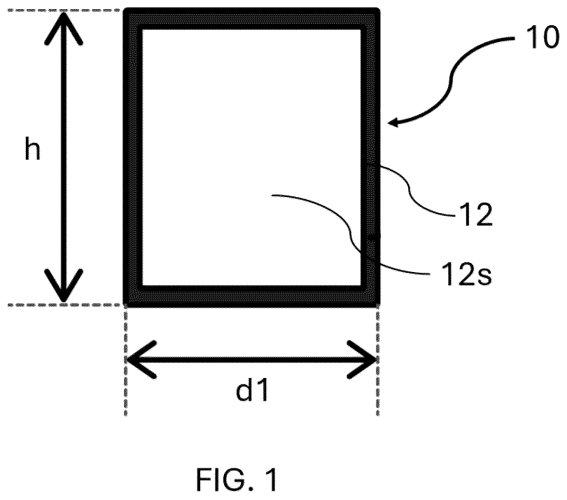

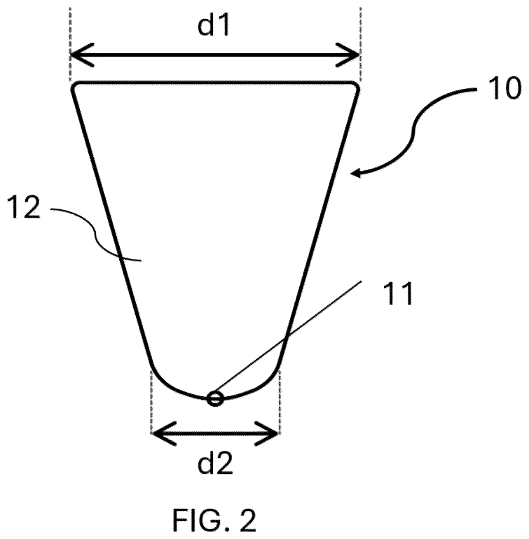

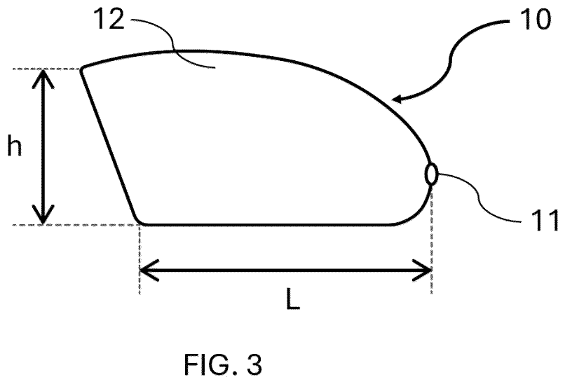

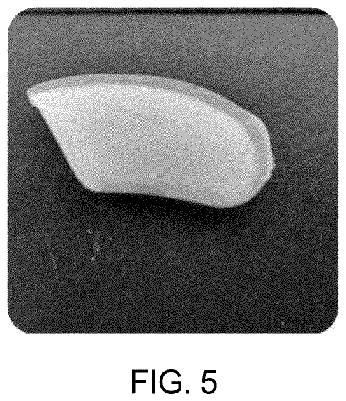

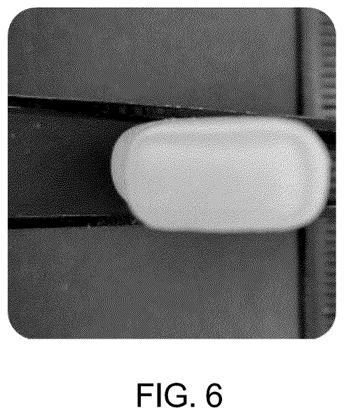

FIGS. 1-6 illustrates the cone-shaped application container 10 containing the styptic composition for pet claws or beaks according to one embodiment. The drawing also explains the method of attachment and the structure of the container 10, which allows for easy removal after use.

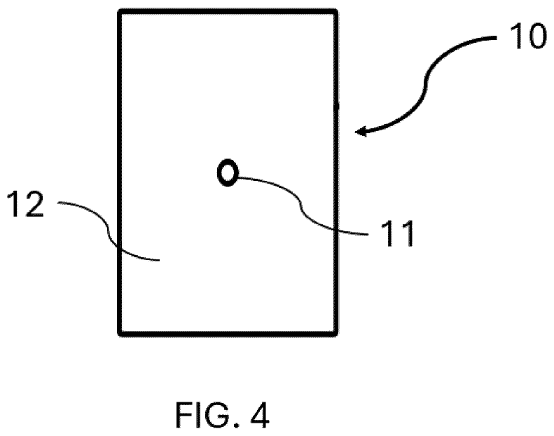

The styptic apparatus for a pet's claw or beak includes a styptic composition configured to stop bleeding from the claw or beak. The styptic apparatus includes an application container 10. The application container 10 includes a container body 12 including a shape that tapers in a front direction. FIG. 4. is a figure of the container body 12 viewed from the front direction. The container body 12 defines an inner space 12s to store the styptic composition. The inner space is configured to accommodate the claw or beak. The container body 12 is configured to cover at least a portion of the claw or beak that is accommodated in the inner space 12s. At least a portion of the claw or beak can be fitted to the container body 12.

In one embodiment, the container 10 may be cone-shaped and made from materials such as PP, PE, PVC, or silicone, designed for easy application of the styptic to the bleeding area of a pet's claw or beak. The container 10 is engineered so that the user can open a cap (not shown in FIGS.) and directly apply a container body 12 to the bleeding area of the claw or beak in a single step. Due to the shape of the container body 12, it is convenient to use, and the styptic adheres easily to the bleeding site, remaining firmly in place even if the pet moves. The container 10 is portable and minimizes contamination risk, allowing for hygienic storage after use. Since the styptic composition must securely adhere to the bleeding area, it has been formulated with adhesive properties, making it unusable without the container 10. The container 10 is designed to maintain the styptic composition in its optimal state, maximizing the hemostatic effect through their interdependent design.

In one embodiment, the application container 10 may be configured such that the claw or beak enters the inner space 12s from a rear direction. FIG. 1. is a figure of the container body 12 viewed from the rear direction. The container body may form a hole 11 at a front end configured to allow air to pass from the inner space. When the user inserts the container body 12 into the claw or beak, air bubbles within the inner space 12s may be expelled to the outside through the hole 11, which may help the styptic composition adhere to the claw or beak. The container body 12 can include an integrated applicator tip having a hole 11.

In one embodiment, the container body 12 may have an opening (shown in FIG. 1) at a rear portion configured to allow the claw or beak to enter the inner space 12s. The application container 10 may further include a cap (not shown in FIGS.) that is detachably connected to the container body 10 to close the opening.

In FIGS. 1-4, the container may be manufactured in a different size. In one example, the distance h is 7-9 mm, the distance L is 10-12 mm, the distance d1 is 5-7 mm, and the distance d2 is 3-5.5 mm. In another example, the distance h is 9-11 mm, the distance L is 11-13 mm, the distance d1 is 6-8 mm, and the distance d2 is 4-6.5 mm. In further another example, the distance h is 11-13 mm, the distance L is 12-14 mm, the distance d1 is 7-10 mm, and the distance d2 is 5-8.5 mm. For example, the angle a1 may be 100-120° and the angle a2 75-85°.

The active ingredients contained in the styptic composition of the present disclosure include sodium carboxy methyl cellulose (SCMC) or hydroxy ethyl cellulose (HEC); poly (ethylene glycol-ran-propylene glycol); glycerol; poloxamer 188; poloxamer 407; benzocaine or lidocaine; calcium phosphate; and kaolin or chitosan.

Sodium Carboxy Methyl Cellulose (SCMC) is a natural polymer material derived from cellulose and is widely used in various industries. It has a structure in which some hydroxyl groups (—OH) of cellulose are substituted with carboxymethyl groups, making it highly soluble in water and able to form viscosity. As a result, it provides viscosity and stability when dissolved. SCMC is used in the food industry as an emulsifier, stabilizer, and thickener, improving texture in styptic compositions like ice cream, sauces, and dressings, and preventing ingredient separation. In pharmaceuticals, it is used in tablet coatings and suspensions to control drug release rates and provide physical stability. In cosmetics, it adds viscosity to lotions and creams and helps styptic compositions spread evenly on the skin.

Glycerol, also known as glycerin, is a simple polyol compound with the chemical formula C₃H₈O₃. It is a colorless, odorless, highly viscous liquid with a sweet taste and mixes well with water. It is highly hygroscopic, meaning it absorbs moisture from the air. Glycerol is used in the food industry as a humectant, sweetener, emulsifier, and stabilizer, helping to improve texture and retain moisture. In pharmaceuticals, it is used in ointments, suppositories, and syrups, aiding in the easy dissolution of suppositories in the body and the release of medication. In cosmetics, glycerol is used as a moisturizer and skin softener, added to styptic compositions like lotions, creams, and soaps to keep the skin hydrated.

Poloxamer is a non-ionic surfactant, used not only for surfactant purposes but also as an emulsifier or stabilizer. Unlike other types of surfactants, non-ionic surfactants do not ionize, have strong dispersion, emulsifying, cleansing, and interfacial adsorption properties, and interact well with other substances. They are effective in small quantities, unlike cationic and anionic surfactants, and are used as detergents, wetting agents, and defoamers across various industries such as textiles, paper, pesticides, pharmaceuticals, and resins.

In the present disclosure, among CMC or HEC and poloxamers, poly(ethylene glycol-ran-propylene glycol), poloxamer 188, and poloxamer 407 were selected for use in the styptic composition for animal's claws or beaks.

Poly (ethylene glycol-ran-propylene glycol) is a copolymer with randomly arranged repeating units, existing as a liquid or semi-solid at room temperature.

A polymer is a compound formed by the polymerization of organic molecules and is classified as a homopolymer, which contains a single type of monomer unit, or a copolymer, which contains two or more types of monomer units. It is a substance with a structure formed by repeating units of the same chemical structure.

Copolymers can be variously classified into block copolymers, random copolymers, alternating copolymers, and graft copolymers based on the arrangement structure of the constituent components.

Block copolymers are mixtures obtained by polymerizing one monomer to form a block and then polymerizing another monomer to form a block repeatedly. Random copolymers are mixtures obtained by disorderly connecting two or more monomers.

Additionally, in the styptic composition of the present disclosure, poly (ethylene glycol-ran-propylene glycol) can be included in an amount of 25-55% by weight, preferably 35% by weight. Glycerol can be included in an amount of 10-35% by weight, preferably 25% by weight. If the combined amount of these two components is less than 40% by weight, the styptic composition becomes too hard, resulting in non-uniform mixing and difficulty adhering to the bleeding area. On the other hand, if it exceeds 70% by weight, the composition may not be uniformly mixed, leading to poor hemostatic effects.

Additionally, the styptic composition of the present disclosure includes poloxamer 407 and poloxamer 188, each with different physical properties depending on the arrangement structure and weight.

Poloxamer 407 used in the present disclosure is a PEG-PPG-PEG triblock copolymer consisting of 101 units of ethylene glycol, 56 units of propylene glycol, and 101 units of ethylene glycol.

Sodium Carboxy Methyl Cellulose (SCMC) or Hydroxy Ethyl Cellulose (HEC) can be included in the composition of the present disclosure in an amount of 1-4% by weight, preferably 2.5% by weight.

Poloxamer 407 can be included in the composition of the present disclosure in an amount of 5-20% by weight, preferably 9% by weight.

If the amount is less than 5% by weight, the styptic composition may not adhere well to the bleeding area. Conversely, if it exceeds 20% by weight, the composition may not be uniformly mixed, resulting in poor hemostatic effects.

Additionally, poloxamer 188, a PEG-PPG-PEG triblock copolymer, can be included in the styptic composition of the present disclosure in an amount of 20-40% by weight, preferably 30% by weight.

If the amount of poloxamer 188 is less than 20% by weight or exceeds 40% by weight, the spreadability decreases, making it difficult to adhere to the bleeding area and use for hemostatic purposes.

Moreover, poloxamer 188 in the present disclosure consists of 80 units of ethylene glycol, 27 units of propylene glycol, and 80 units of ethylene glycol in repeating units.

The styptic composition of the present disclosure may include calcium phosphate, kaolin, or chitosan as active ingredients.

Kaolin is a substance derived from kaolinite and appears white or light yellow. It has a small molecular size and mineral composition, making it non-reactive and non-immunogenic in the body. Kaolin activates the coagulation cascade, particularly activating plasma factors such as Factor XII, Factor XI, and pre-kallikrein, as well as a dual action of activating the Factor XI-like protein in platelets. However, kaolin has a small surface area, few substituents, and high dispersion in water, which can result in poor adhesion when applied to textiles.

In the present disclosure, a styptic composition with excellent hemostatic effects and ease of application to animal's claw or beak was developed using kaolin. The kaolin can be included in an amount of 0.1 to 3% by weight, preferably 1% or less, based on the total weight of the styptic composition.

If the amount of kaolin used is less than 0.1% by weight, the hemostatic effect is insufficient. If it exceeds 3% by weight, it becomes difficult to prepare a uniform mixture with the other poloxamer components.

Chitosan is a derivative of chitin and is insoluble in water and alkali but dissolves well in weak acids such as lactic acid, citric acid, and acetic acid. It is broken down by enzymes and easily absorbed. Chitosan has biocompatibility, biodegradability, non-toxicity, and non-immunogenic properties.

Additionally, chitosan, being a positively charged polysaccharide, binds to the negatively charged surface of red blood cell membranes, promoting thrombus formation. Its mucoadhesive properties induce platelet aggregation and calcium ionization, thereby promoting blood coagulation.

Chitosan can be included in the styptic composition in an amount of 0.1 to 3% by weight, preferably 1% by weight.

If the amount of chitosan used is less than 0.1% by weight, the hemostatic effect is insufficient. If it exceeds 3% by weight, it becomes difficult to prepare a uniform mixture with the other poloxamer components.

The styptic composition of the present disclosure may also include benzocaine or lidocaine as an active ingredient.

Benzocaine is a local anesthetic primarily used to relieve pain on the skin or mucous membranes. It is a colorless to white solid that is poorly soluble in water but dissolves well in organic solvents such as alcohol and ether.

Benzocaine works by blocking sodium ion channels on nerve cell membranes, preventing the transmission of nerve signals. As a result, it inhibits sensations such as pain, heat, and itching in the affected area.

When a styptic composition is applied to a bleeding area, localized pain may be felt. By incorporating benzocaine or lidocaine into the styptic composition, it can help reduce pain while the composition is adhered to the bleeding area.

In place of benzocaine, other local anesthetics such as lidocaine or prilocaine can be used.

The styptic composition for animal's claws or beaks can quickly and continuously stop bleeding from animal's claw or beak and can be easily applied to the bleeding area by simply removing the cap.

Additionally, once attached to the bleeding area, the composition remains securely in place for an extended period without easily falling off, offering convenience as it does not interfere with the animal's movement. It also provides an antibacterial effect, helping prevent infections caused by harmful bacteria.

Although not limited to these, the styptic composition for animal's claw or beak of the present disclosure can be applied to animals such as dogs, cats, or birds.

Furthermore, the present disclosure provides a method for manufacturing the styptic composition for animal's claw or beak, preferably including the steps of: (1) mixing and heating sodium carboxy methyl cellulose (SCMC) or hydroxy ethyl cellulose (HEC); poly(ethylene glycol-ran-propylene glycol); glycerol; poloxamer 188; poloxamer 407; benzocaine or lidocaine; calcium phosphate; kaolin or chitosan to prepare a mixture; (2) deaerating the mixture to remove bubbles; and (3) pouring the deaerated mixture into a mold and refrigerating to solidify.

The method described in detail is as follows.

First, sodium carboxy methyl cellulose (SCMC) or hydroxy ethyl cellulose (HEC); poly (ethylene glycol-ran-propylene glycol); glycerol; poloxamer 188; poloxamer 407; benzocaine or lidocaine; calcium phosphate; kaolin or chitosan are mixed and heated to prepare a mixture.

The mixture is prepared by adding the following components based on the total weight percentage of the composition: 1-4% by weight of sodium carboxy methyl cellulose (SCMC) or 1-4% by weight of hydroxy ethyl cellulose (HEC), 25-55% by weight of poly(ethylene glycol-ran-propylene glycol), 10-35% by weight of glycerol, 10-40% by weight of poloxamer 188, 1-15% by weight of poloxamer 407, 0.1-3% by weight of lidocaine, 1-4% by weight of calcium phosphate, and 0.1-2% by weight of kaolin or chitosan. These components are mixed and heated to prepare the mixture.

The heating is carried out in a reactor at a temperature of 60-90° C. for 16-24 hours while mixing.

After the preparation of the mixture is complete, a deaeration process is performed to remove air bubbles contained in the mixture using a vacuum oven.

The deaerated mixture is then poured into an aluminum or silicone mold and stored at 0° C. to 4° C. for 1 hour, followed by 24 hours at room temperature to solidify.

After confirming the appearance and contamination status of the solidified styptic composition, it is put back into the reactor.

The solidified composition is reheated in the reactor at a temperature similar to body temperature, between 25° C. and 45° C., preferably between 33° C. and 38° C., and mixed until it becomes a paste.

The styptic composition, which is formulated in a paste-like consistency, is injected into a container 10 designed in the shape of animal's claw or beak, made from materials such as PP, PE, PVC, or silicone, as illustrated in the drawings, to complete the styptic apparatus. This container 10 is modeled after the shape of animal's claw or beak, allowing the user to apply it directly to the bleeding area in one step.

The user can easily open the cap of the styptic for a pet provided by the present disclosure and directly apply it to the bleeding area. Due to its excellent adhesive properties, there is no need to continuously hold the styptic in place, as is often required with conventional powder or liquid styptics. Additionally, since the composition is made from water-soluble ingredients, it can be easily wiped off with a wet tissue once hemostasis is achieved, leaving the area clean. The inclusion of antibacterial agents helps reduce the risk of infection, ensuring that the styptic composition can be hygienically handled after use.

The present disclosure also provides a method for stopping bleeding from animal's claw or beak using the styptic apparatus and the styptic composition.

This method involves simply removing the cap of the application container 10 provided with the styptic composition for animal's claw or beak of the present disclosure and attaching it to the bleeding area of the animal's claw or beak.

The following examples are provided to describe the present disclosure in more detail.

These examples are intended to illustrate the disclosure more concretely and are not intended to limit the scope of the present disclosure.

Hereinafter, one example (i.e., Example 1) of a method for manufacturing a styptic composition for pet's claw or beak contained in an applicator container 10 is explained. The styptic composition for pet using the ingredients listed in Table 1 below through the following method can be prepared.

First, the ingredients listed in Table 1 are mixed and heated to 80° C., dissolving the ingredients and thoroughly mixing them. Next, a vacuum chamber is used to perform a deaeration process to remove air bubbles present in the mixture prepared in the above process. The deaerated mixture is then poured into an aluminum or silicone mold and stored at 0° C. to 4° C. for 60 minutes to solidify, followed by further solidification at room temperature for 24 hours. The solidified styptic composition is then put back into the reactor and reheated at a temperature similar to body temperature, between 25° C. and 45° C., preferably between 33° C. and 38° C., and mixed until it becomes a paste. The paste-form styptic composition is then dispensed into PP, PE, PVC, or silicone-shaped containers 10 designed in the shape of animal's claw or beak to complete the styptic composition for claw or beak. After labeling, the styptic composition is checked for appearance and contamination and packaged in a paper box to manufacture the styptic composition for a pet according to the present disclosure. A photograph of the styptic apparatus for pet's claws or beaks manufactured by the method of the present disclosure is shown in FIG. 1.

TABLE 1
Ingredients and Contents for the Preparation
of Styptic Composition for Pet (Unit: %(w/w))

| | | | Comparative | Comparative | |
|---|---|---|---|---|---|
| Ingredient | Example1 | Example2 | Example1 | Example2 | Supplier |
| Sodium Carboxy | 1.5 | 3 | 5 | 0 | Merck |
| Methyl Cellulose | | | | | |
| Poly(ethylene glycol- | 35 | 40 | 40 | 25 | Merck |
| ran-propylene glycol) | | | | | |
| Glycerol | 25 | 20 | 20 | 20 | Merck |
| Poloxamer 188 | 30 | 20 | 15 | 40 | Merck |
| Poloxamer407 | 5 | 10 | 15 | 10 | Merck |
| Benzocaine | 1 | 2 | 1 | 1 | Merck |
| Calcium Phosphate | 1 | 3 | 2 | 2 | Merck |
| Kaolin | 0.5 | 1 | 1 | 1 | Merck |
| Chitosan | 1 | 1 | 1 | 1 | Merck |

Here, Sodium Carboxy Methyl Cellulose (SCMC) is a polymer compound derived from cellulose, commonly used as a viscosity modifier, stabilizer, and emulsifier. Simply put, it is a compound where carboxymethyl groups (—CH₂—COOH) are attached to cellulose. Additionally, poly (ethylene glycol-ran-propylene glycol), a random copolymer with randomly arranged repeating units, exists in a liquid or semi-solid form at room temperature (1˜30° C.). Poloxamer 407 is a PEG-PPG-PEG triblock copolymer consisting of 101 units of ethylene glycol, 56 units of propylene glycol, and 101 units of ethylene glycol. Poloxamer 188 is also a PEG-PPG-PEG triblock copolymer, consisting of 80 units of ethylene glycol, 27 units of propylene glycol, and 80 units of ethylene glycol. benzocaine, with the molecular formula C₁₄H₂₂N₂O, is an amide-type local anesthetic primarily used for pain relief or anesthesia.

Hereinafter, an experimental example (i.e., Experimental Example 1) of an analysis of the hemostatic effect of a styptic composition for pets contained in an applicator container 10 is explained.

The hemostatic effects of the styptic compositions prepared in Examples 1 and 2 and Comparative Examples 1 and 2 from the above-mentioned Example 1 were analyzed. For this purpose, wounds were induced on the claws of pet dogs, and each styptic composition prepared in Example 1 was applied to the wound areas. The time taken for hemostasis was then recorded for each case.

TABLE 2
Analysis of Hemostasis

| | | | Comparative | Comparative |
|---|---|---|---|---|
| Criteria | Example1 | Example2 | Example 1 | Example 2 |
| Time to Achieve | Immediate Hemostasis | Immediate Hemostasis | No Hemostasis | No Hemostasis |
| Hemostasis | (within 3 minutes | (within 5 minutes | | |
| | after application) | after application) | | |
| Rebleeding | No Rebleeding | No Rebleeding | Rebleeding | Rebleeding |
| Occurrence | | | Occurred | Occurred |
| Ease of Use | Easy | Easy | Very Inconvenient | Very Inconvenient |

As shown in Table 2, the analysis results indicate that the styptic composition treatment groups of the present disclosure, Examples 1 and 2, exhibited superior hemostatic effects compared to the styptic compositions of Comparative Examples 1 and 2. Notably, in the case of Example 1, hemostasis was achieved rapidly within 1 minute without any occurrence of rebleeding. Therefore, these results demonstrate that the styptic composition for pets according to the present disclosure exhibits excellent immediate hemostatic ability and hemostasis maintenance for bleeding areas on pet's claws or beaks. Furthermore, in terms of ease of use, Examples 1 and 2 could be easily applied to the claw or beak in one step, whereas Comparative Example 1 was too runny and leaked from the container 10, and Comparative Example 2 had a hard texture, making it difficult to fill the container 10 adequately, thus very inconvenient to handle.

Hereinafter, an experimental example (i.e., Experimental Example 2) of an analysis of the adhesion ability of a styptic composition for pets contained in an applicator container 10 to the bleeding area is explained.

The inventor conducted a study to develop a new styptic agent that, unlike conventional powder or liquid hemostatic agents, does not restrict the everyday movement of animals, is easy to use, and exhibits excellent hemostatic effects even during free movement. They developed the styptic composition for pets, such as those in Examples 1 and 2, in the above-mentioned Example 1. To evaluate the continuous adhesion ability of the styptic composition of the present disclosure when applied to a bleeding wound area, they measured the adhesion time, and the results are shown in Table 3 below.

TABLE 3
Adhesion Ability Analysis of the Styptic Composition for Pet

| | | | Comparative | Comparative |
|---|---|---|---|---|
| Criteria | Example1 | Example2 | Example1 | Example2 |
| Adhesion | Remained | Remained | Remained | Detached |
| Duration | attached | attached | attached | within |
| | for 3 days | for 3 days | for 1 day | 10 minutes |

This table shows the adhesion maintenance results of the styptic compositions. Examples 1 and 2 remained securely attached for 3 days, while Comparative Example 1 only stayed attached for 1 day. Comparative Example 2 detached within 10 minutes, indicating poor adhesion performance.

As shown in Table 3, the analysis results indicate that the styptic compositions of the present disclosure, Example 1 and Example 2, adhered to the bleeding area for a longer period compared to Comparative Examples 1 and 2. Particularly, in the case of Comparative Example 2, the composition detached from the bleeding area within 10 minutes after application.

Therefore, it can be concluded that the styptic composition of the present disclosure maintains good adhesion to the bleeding area for an extended period, thereby continuously sustaining the hemostatic effect.

Additionally, as shown in FIG. 1, the styptic composition of the present disclosure is provided in a flexible semi-solid or paste form within a cylindrical application container 10, allowing it to be applied to the bleeding area in a single step, effectively inducing hemostasis.

Hereinafter, an experimental example (i.e., Experimental Example 3) of an analysis of the antibacterial effect of a styptic composition for pets contained in an applicator container 10 is explained.

TABLE 4
Antibacterial Activity Analysis of the Styptic Composition for Pets

| | | | Comparative | Comparative |
|---|---|---|---|---|
| Criteria | Example 1 | Example 2 | Example 1 | Example 2 |
| E. coli inhibition | 99% | 99% | 60% | 77% |
| ability (24 hours) | | | | |

As shown in Table 4, the styptic compositions of the present disclosure, Example 1 and Example 2, exhibited significantly superior antibacterial activity compared to the comparative examples. Therefore, the styptic composition of the present disclosure not only demonstrates excellent hemostatic effects and high adhesion ability but also effectively inhibits the attachment and proliferation of bacteria at the bleeding site, providing outstanding antibacterial properties.

In the present disclosure, the user simply needs to open the cap of the container 10 and directly apply the container body 12 to the bleeding area in a single step. Thanks to the shape of the container body 12 and the adhesive properties of the styptic composition, the styptic composition adheres easily to the bleeding site and remains firmly in place even if the pet moves, maintaining its hemostatic effect for an extended period. Once the bleeding has stopped, the styptic composition can be easily wiped off with a wet tissue as it is made from water-soluble ingredients. Additionally, the inclusion of antibacterial agents helps reduce the risk of infection, ensuring hygienic handling after use.

The present disclosure can quickly stop bleeding from pet's claws or beaks and ensure that the styptic composition remains stably attached to the bleeding area for an extended period, maintaining the hemostatic effect. Additionally, the antibacterial ingredients in the styptic composition reduce the risk of infection at the bleeding site, and the composition can be easily removed with a wet tissue, ensuring cleanliness after use. This enables prompt first aid in case of pet claw (or beak) bleeding, improving the quality of life for pets.

So far, the present disclosure has been described with reference to its preferred embodiments. However, it will be understood by those skilled in the art that various modifications and changes can be made without departing from the essential characteristics of the present disclosure. Therefore, the disclosed embodiments should be considered as illustrative rather than restrictive. The scope of the present disclosure is defined by the appended claims, and all differences within the scope equivalent to the claims should be interpreted as being included in the present disclosure.

What is claimed is:

1. A styptic apparatus for a pet's claw or beak comprising:
a styptic composition configured to stop bleeding from the claw or beak; and
an application container including a container body including a shape that tapers in a front direction,
wherein the container body defines an inner space to store the styptic composition,
the inner space is configured to accommodate the claw or beak, and
the container body is configured to cover at least a portion of the claw or beak that is accommodated in the inner space.

2. The styptic apparatus of claim 1, wherein the application container is configured such that the claw or beak enters the inner space from a rear direction.

3. The styptic apparatus of claim 2, wherein the container body forms a hole at a front end configured to allow air to pass from the inner space.

4. The styptic apparatus of claim 1, wherein the container body has an opening at a rear portion configured to allow the claw or beak to enter the inner space.

5. The styptic apparatus of claim 4, wherein the application container further includes a cap that is detachably connected to the container body to close the opening.

6. The styptic apparatus of claim 4, wherein the container body forms a hole at a front end configured to allow air to pass from the inner space.

7. The styptic apparatus of claim 1, wherein the styptic composition includes:
sodium carboxy methyl cellulose or hydroxy ethyl cellulose;
poly(ethylene glycol-ran-propylene glycol);
glycerol;
poloxamer 188;
poloxamer 407;
benzocaine or lidocaine;
calcium phosphate; and
kaolin or chitosan.

8. The styptic apparatus of claim 7, wherein the styptic composition comprises:
1-4 weight percent of sodium carboxy methyl cellulose or hydroxy ethyl cellulose;
25-55 weight percent of poly(ethylene glycol-ran-propylene glycol);
10-35 weight percent of glycerol;
10-40 weight percent of poloxamer 188;
1-15 weight percent poloxamer 407;
0.1-3 weight percent of benzocaine or lidocaine;
1-4 weight percent of calcium phosphate; and
0.1-2 weight percent of kaolin or chitosan.

9. The styptic apparatus of claim 1, wherein the container body is made of polyethylene (PE), polypropylene (PP), Polyvinyl chloride (PVC), or silicone.

10. A method for manufacturing the styptic apparatus of claim 1, comprising manufacturing the styptic composition, wherein the manufacturing the styptic composition includes:
(a) mixing and heating sodium carboxy methyl cellulose or hydroxy ethyl cellulose, poly(ethylene glycol-ran-propylene glycol), glycerol, poloxamer 188, poloxamer 407, benzocaine or lidocaine, calcium phosphate, and kaolin or chitosan to prepare a mixture;
(b) performing a deaeration process to remove air bubbles contained in the mixture;
(c) pouring the deaerated mixture into a mold and refrigerating the mixture to solidify; and
(d) reheating the solidified mixture to a designated temperature while kneading it into a paste form.

11. The method for manufacturing the styptic apparatus of claim 10, wherein, in the mixing and heating, the mixture is prepared by mixing:
1-4 weight percent of sodium carboxy methyl cellulose or hydroxy ethyl cellulose;
25-55 weight percent of poly(ethylene glycol-ran-propylene glycol);
10-35 weight percent of glycerol;
10-40 weight percent of poloxamer 188;
1-15 weight percent poloxamer 407;
0.1-3 weight percent of benzocaine or lidocaine;
1-4 weight percent of calcium phosphate; and
0.1-2 weight percent of kaolin or chitosan.

12. The method for manufacturing the styptic apparatus of claim 10, wherein a heating temperature of the mixture in the mixing and heating is 60-90° C., and the heating time in the mixing and heating is 16-24 hours.

13. The method for manufacturing the styptic apparatus of claim 10, wherein the deaeration process is performed by using a vacuum oven.

14. The method for manufacturing the styptic apparatus of claim 10, wherein the solidified mixture is reheated at 25° C.-45° C. to form a paste in the reheating, and
the method further comprises: (f) dispensing the mixture into the container body after the reheating.
